(19) United States
(12) Patent Application Publication
(10) Pub. No.: US 2006/0162489 A1
(43) Pub. Date: Jul. 27, 2006

(54) ADJUSTABLE PEDAL

(76) Inventors: Elie-Jean Joseph Raad, New Wetminster (CA); Paul Steven Schranz, Bowen Island (CA)

Correspondence Address: PAUL STEVEN SCHRANZ, BOX G-30 RR1, BOWEN ISLAND, BC, V0N 1G0, CA

(21) Appl. No.: 10/905,841

(22) Filed: Jan. 22, 2005

(51) Int. Cl. G05G 1/14

(52) U.S. Cl. 74/594.7

(57) ABSTRACT

There is provided an adjustable pedal comprising a pedal axle, a pedal body and a pedal adjustment means. The pedal axle has a first end and a second end opposite the first end thereof. The first end is adapted to be fitted to a pedal crank. The pedal axle has a first longitudinal axis and a radial line perpendicular to the longitudinal axis. The pedal body supports a shoe of a cyclist. The pedal body has a first lateral side, a second lateral side and a shoe side. The second lateral side is opposite the first lateral side. The shoe side is between the first lateral side and the second lateral side. The pedal adjustment means is for adjustably connecting the pedal axle to the pedal body. The first longitudinal axis of the pedal axle is substantially perpendicular to the first and second lateral sides of the pedal body. The pedal adjustment means provides a transverse adjustment for the second end of the pedal axle between the first and second lateral sides. The pedal adjustment means also provides a radial adjustment of the pedal body along the radial line of the pedal axle.

### BACKGROUND OF THE INVENTION

The present invention relates to an adjustable pedal, and in particular, an adjustable pedal for a bicycle.

Conventional pedals and bicycles are constructed, in part, with the ideal human body in mind. For example, it is assumed that the bicycle rider is perfectly symmetrical about a vertical plane that divides the rider into a left side and a right side, with each side having an arm and a leg. The ideal symmetry includes legs that are of equal length, hip-joints having identical articulation and ankles having identical articulation. However, the population as a whole does not conform to this assumption.

It has been found that about 50% of the population has a leg length difference. Leg length differences can be due to anatomical short leg or functional short leg. Anatomical short leg is the difference in the length of the structures (femur, tibia & fibula) from the ground to the femur head compared between the left and right leg. The causes of anatomical short leg could be from trauma, polio, birth defect, surgery or asymmetrical growth. Functional short leg is the difference in the alignment of the structures from the ground to the femur head compared between the left and right leg. The cause of functional short leg is usually excessive unilateral pronation of the foot or ankle, but it can also be caused by a valgus or varus unilateral knee.

Cyclists with leg length differences experience, generally, two effects while cycling. If the distance between the seat and the pedal at the bottom of the pedal stroke is too great, then the cyclist would experience pain behind the knee due to over stretching of the muscles. In the other case, if the distance between the seat and the pedal at the bottom of the pedal stroke is too little, then the cyclist would experience pain in the hip or knee joint due to excessive forces.

Traditionally, cyclists have purchased cranks of different lengths to offset the leg length difference problem. However, a crank of a smaller length reduces the torque during the power stroke of the pedal cycle. Also, some cyclists have used spacers between their shoe and the cleat for extra height above the cleat engagement mechanism; however, the spacer would protrude from the sole of the shoe and make walking difficult.

A portion of the population also has an excessive toe-out stance, which is usually caused by abnormal rotation of the hip-joint, but can also be caused by structural deformities in the lower skeleton extremity. Excessive toe-out is a significant problem for cyclists that use a bicycle cleat to attach to their pedal. In this case, the cyclist usually attaches the cleat to the sole of the shoe in such a manner that their natural position of toe-out is maintained when the shoe is connected to the pedal. However, excessive rotation of the heel towards the wheel of the bicycle can result in the heel coming dangerously close to the spokes and in some cases touching them. Typically, the cyclist with toe-out has had to adopt an unnatural foot position which limited their cycling efficiency and force and also caused stress in other joints such as the knee.

In U.S. Pat. No. 6,564,676 by Bezet, a cycle pedal with improved adjustable positioning is provided. The pedal includes adjustment elements of the transverse position and the angular position of the pedal body relative to the pedal axle. The transverse position adjustment provides for a variable clearance between the pedal body and the crank and is provided by a casing (7) having threads (20) that is threadedly received by a socket (11) in seat (12). The angular position adjustment provides for an inversion or eversion of the foot with respect to the crank. Note, however, that the seat (12) must be interchanged with an alternative seat which has a different angular relationship between lines A-A and B-B as shown in FIGS. 3a-e. In this sense, the angular position of the pedal itself is not adjustable, but rather a different pedal needs to be assembled that has a different angular relationship. This pedal does not offer an adjustment for the orthogonal distance between the longitudinal axis of the axle (8) and the shoe bear boundary of the pedal body (1).

In U.S. Pat. No. 4,599,915 by Hlavac et al. a pedal which is adjustable in one to three planes of movement is provided. The pedal comprises a platform mounted on a shaft for supporting the foot, and one or more of the following means: means for positioning the platform along a radial axis generally perpendicular to the axis of the shaft to provide a lifted position of the foot, means permitting the platform to tilt about the radial axis in a direction generally parallel to the shaft axis to provide inverted and everted positions for the foot, and means permitting the platform to pivot about the radial axis to provide toe-in and toe-out positions for the foot. However, this pedal provides no means to adjust the transverse position of the platform with respect to the crank.

In U.S. Pat. No. 4,488,453 by Drugeon et al., a pedal is provided that comprises a pedal body and a pedal shaft. The pedal body is adjustable with respect to the pedal shaft in a transverse translational motion (D_{T}) of said pedal body, a longitudinally translational motion (D_{L}), a pivoting motion (R_{V}) allowing for a toe-in or toe-out adjustment and another pivoting motion (R_{L}) allowing for an inverted or everted foot postion. However, this pedal provides no adjustment for the orthogonal distance between the longitudinal axis of the pedal shaft (7) and the shoe bear boundary of the pedal body (1).

There is a need for an adjustable pedal that provides a transverse position adjustment between the pedal body and the crank and also provides a height adjustment of the shoe bearing boundary of the pedal body above the longitudinal axis of the pedal axle.

### BRIEF SUMMARY OF INVENTION

In one aspect of the present invention there is provided an adjustable pedal comprising a pedal axle, a pedal body and a pedal adjustment means for adjusting the pedal axle in relation to the pedal body. The pedal axle has a first end and a second end opposite the first end thereof. The first end is adapted to be fitted to a pedal crank. The pedal axle has a first longitudinal axis and a radial line perpendicular to the longitudinal axis. The pedal body supports a shoe of a cyclist. The pedal body has a first lateral side, a second lateral side and a shoe side. The second lateral side is opposite the first lateral side. The shoe side is between the first lateral side and the second lateral side. The pedal adjustment means adjustably connects the pedal axle to the pedal body. The first longitudinal axis of the pedal axle is substantially perpendicular to the first and second lateral sides of the pedal body. The pedal adjustment means provides a transverse adjustment for the second end of the pedal axle between the first and second lateral sides. The pedal adjustment means provides a radial adjustment of the pedal body along the radial line of the pedal axle.

In another aspect of the present invention there is provided a combination bicycle and pedal. The pedal is adjustable and comprises a pedal axle, a pedal body and a pedal adjustment means for adjusting the pedal axle in relation to the pedal body. The pedal axle has a first end and a second end opposite the first end thereof. The first end is adapted to be fitted to a pedal crank. The pedal axle has a first longitudinal axis and a radial line perpendicular to the longitudinal axis. The pedal body supports a shoe of a cyclist. The pedal body has a first lateral side, a second lateral side and a shoe side. The second lateral side is opposite the first lateral side. The shoe side is between the first lateral side and the second lateral side. The pedal adjustment means adjustably connects the pedal axle to the pedal body. The first longitudinal axis of the pedal axle is substantially perpendicular to the first and second lateral sides of the pedal body. The pedal adjustment means provides a transverse adjustment for the second end of the pedal axle between the first and second lateral sides. The pedal adjustment means provides a radial adjustment of the pedal body along the radial line of the pedal axle.

In another aspect of the present invention there is provided a method of adjusting a pedal for a bicycle. The pedal comprises a pedal axle, a pedal body and a pedal adjustment means for adjusting the pedal axle in relation to the pedal body. The pedal axle has a first end and a second end opposite the first end thereof. The first end is adapted to be fitted to a pedal crank. The pedal axle has a first longitudinal axis and a radial line perpendicular to the longitudinal axis. The pedal body supports a shoe of a cyclist. The pedal body has a first lateral side, a second lateral side and a shoe side. The second lateral side is opposite the first lateral side. The shoe side is between the first lateral side and the second lateral side. The pedal adjustment means adjustably connects the pedal axle to the pedal body. The first longitudinal axis of the pedal axle is substantially perpendicular to the first and second lateral sides of the pedal body. The pedal adjustment means provides a transverse adjustment for the second end of the pedal axle between the first and second lateral sides. The pedal adjustment means provides a radial adjustment of the pedal body along the radial line of the pedal axle. The method comprises the steps of adjusting the radial distance of the pedal body along the radial line of the pedal axle, and adjusting the transverse position of the second end of the pedal axle between the first and second lateral sides.

### BRIEF DESCRIPTION OF DRAWINGS

The invention will be more readily understood from the following description of preferred embodiments thereof given, by way of example only, with reference to the accompanying drawings, in which:

FIG. 1 is a view in perspective of an adjustable pedal according to one embodiment of the present invention;

FIG. 2a-b are broken away views in perspective of the adjustable pedal of FIG. 1;

FIG. 3 is another broken away view in perspective of a portion of the adjustable pedal of FIG. 1;

FIGS. 4a-c are views in side elevation showing two different positions of the adjustable pedal of FIG. 1.;

FIGS. 5a-c are plan views corresponding to the views in FIGS. 3a-c respectively;

FIG. 6 is a view in perspective of an adjustable pedal according to another embodiment of the invention;

FIG. 7 is another view in perspective of the adjustable pedal of FIG. 6;

FIG. 8 is a view in perspective of an adjustable pedal according to another embodiment of the present invention;

FIG. 9 is a view in side elevation of the adjustable pedal of FIG. 8;

FIG. 10 is a view in end elevation of the adjustable pedal of FIG. 8; and

FIG. 11 is another view in perspective of the adjustable pedal of FIG. 8.

### DESCRIPTION OF THE PREFERRED EMBODIMENTS

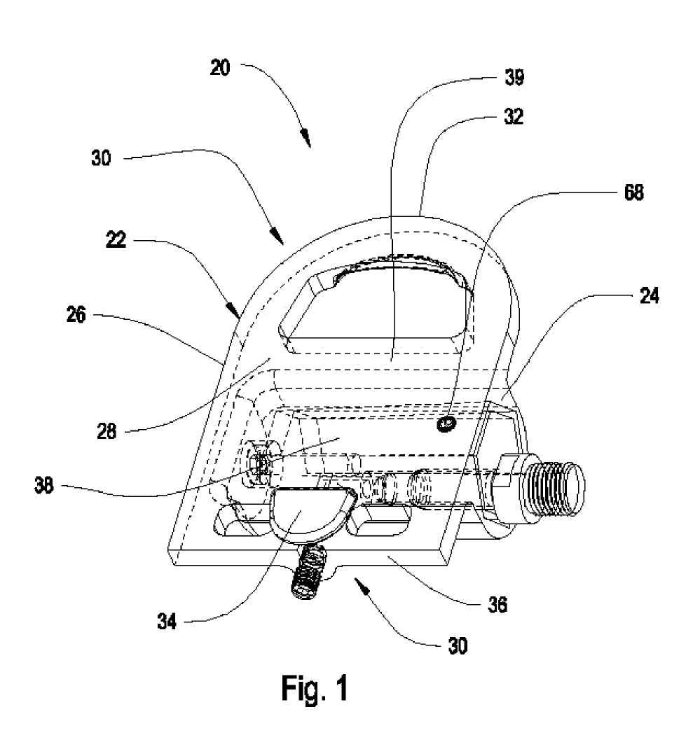

In a first embodiment of the present invention, illustrated in FIG. 1, there is provided an adjustable pedal indicated generally by reference numeral 20. The adjustable pedal 20 is for a left foot, however, a similar pedal exists for a right foot. The adjustable pedal includes a pedal body 22 having a first lateral side 24, a second lateral side 26 and a shoe side 28.

The shoe side 28 includes a shoe placement means, indicated generally by reference numeral 30, for positioning a shoe on the pedal body 22. The shoe placement means 30 is a cleat engagement mechanism in this example, but can be other mechanical structures like a pedal platform, or a pedal platform and a cage. The shoe placement means 30 is engaged by a cleat attached to the bottom of the shoe in order to securely connect the shoe to the pedal 20. The shoe placement means 30 includes a front fixed hook 32 and a rear movable hook 34, in this example, but can be other mechanical arrangements.

To engage the shoe placement means 30 a cyclist hooks a toe side of the cleat on the front fixed hook 32, and then presses the heel of the shoe towards the shoe side 28. A heel side of the cleat then contacts and forces the rear moveable hook 34 backwards towards an end 36 allowing the cleat to drop down and come to rest on the shoe side 28.

The shoe side 28 has a plane 38 defining a shoe bearing boundary 39. In this example the cleat of the shoe rests upon the shoe bearing boundary 39, but in other embodiments a sole of the shoe could rest upon the shoe bearing boundary 39.

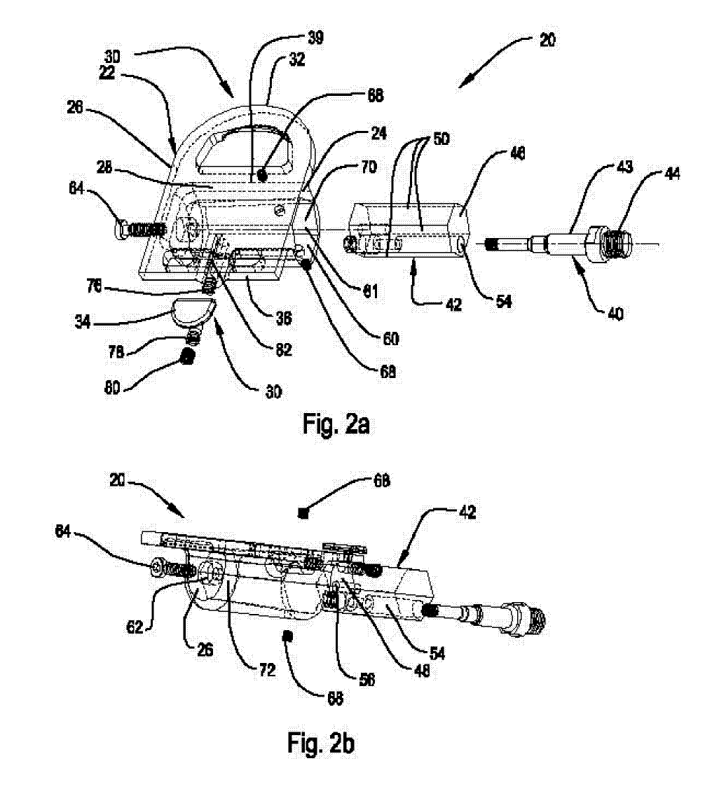

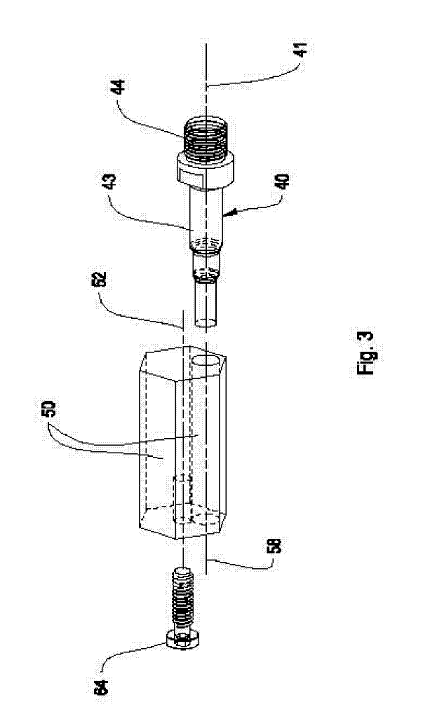

Referring now to FIGS. 2a-b and 3, the adjustable pedal 20 also includes an axle 40 and an elongate member 42. The axle 40 has a shaft 43 and an end 44 adapted to be connected to a pedal crank. The axle 40 has a longitudinal axis 41 and a radial axis.

The elongate member 42 has a first end 46, a second end 48 and a plurality of sides 50. In this example the elongate member 42 is in the form of a right prism, but can be other shapes. A right prism is a polyhedron having two parallel, planar and congruent polygonal bases, which in this example are the first end 46 and second end 48, and with other faces being rectangles, which in this example are the plurality of sides 50. The first end 46 and the second end 48 are regular hexagons in this example, but can be other types of regular polygons such as pentagons (5 sides), heptagons (7 sides), octagons (8 sides), decagons (10 sides), dodecagons (12 sides), and tetradecagons (14 sides). In other embodiments, the first end 46 and the second end 48 can be other shapes having an axis of symmetry, such as rectangles or circles.

The elongate member 42 has a longitudinal axis 52, a first bore 54 and a second bore 56. The first bore 54 has a longitudinal axis 58. The longitudinal axis 52 of the elongate member 42 is parallel to and offset from the longitudinal axis 58 of the first bore 54.

The first bore 54 receives the shaft 43 of the axle 40 such that the longitudinal axis 58 of the first bore is in line with the longitudinal axis 41 of the axle. In this example a conventional bearing unit, which is not shown but well known to one skilled in the art, rotatably couples the shaft 43 to the elongate member 42. In other embodiments of the invention, the end 44 of the axle 40 is rotatably coupled to the shaft 43, and the shaft is non-rotatably engaged by the first bore 54 of the elongate member 42.

The first lateral side 24 has an elongate hollow portion 60 extending towards the second lateral side 26. The elongate hollow portion has a longitudinal axis 61 and has the same shape as the elongate member 42. The elongate hollow portion 60 is telescopically, mutually engageable with the elongate member 42 in a plurality of orientations.

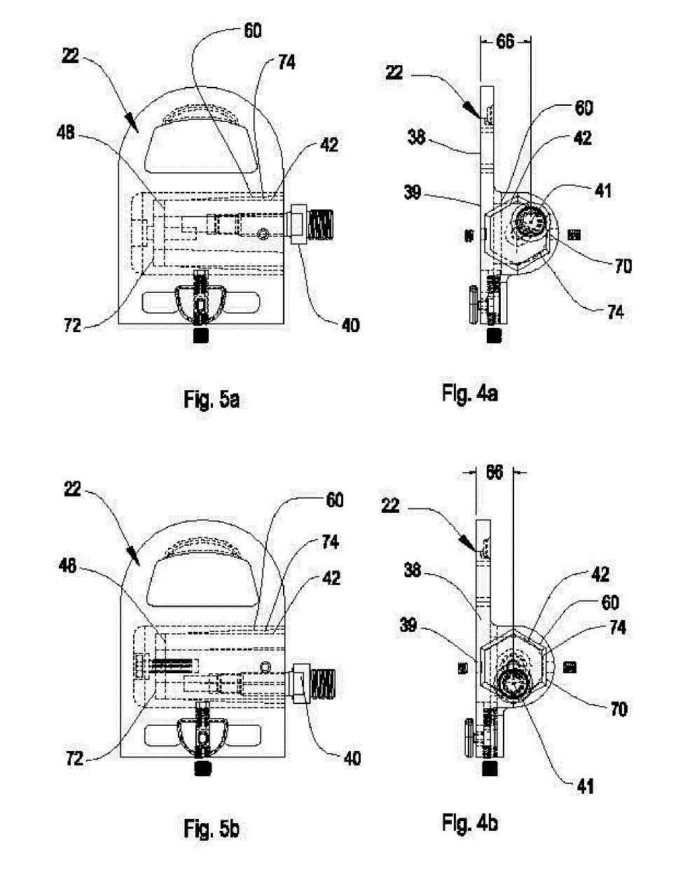

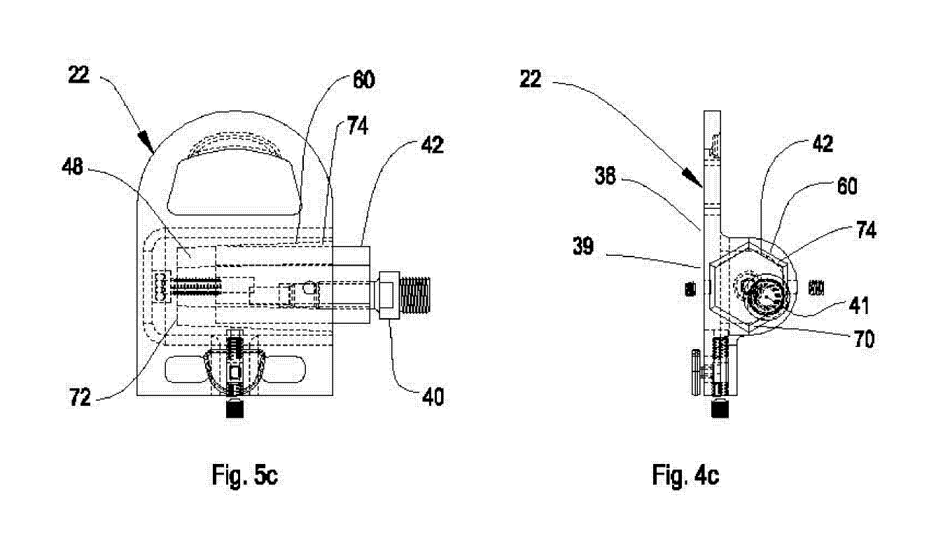

Referring to FIGS. 4a-c and 5a-c, three different mutually engaged orientations of the elongate member 42 in the elongate hollow portion 60 are illustrated. The position of the pedal axle 40 relative to the pedal body 22 in each of the orientations is unique. There exists a line segment 66 along the radial axis of the pedal axle 40. The line segment 66 is orthogonal to the shoe bearing boundary 39 and extends between the longitudinal axis 41 of the axle 40 and the shoe bearing boundary 39. Preferably, the line segment 66 has a unique length for each of the plurality of orientations of the elongate member 42 and the elongate hollow portion 60. However, the line segment 66 has at least two unique lengths for the plurality of orientations.

By changing the orientation of the elongate member 42 in the elongate hollow portion 60, which changes the length of the line segment 66, different height adjustments of the cyclists shoe above the longitudinal axis 41 of the pedal axle 40 can be achieved. This has the advantage of allowing cyclists with leg length differences to find an appropriate height adjustment for maximum pedaling efficiency and comfort.

Referring back to FIGS. 2a-b, the second lateral side 26 has a bore 62 that extends to the elongate hollow portion 60. The bore 62 threadedly receives a screw 64 which projects into the elongate hollow portion 60 and is threadedly received by the bore 56 at the second end 48 of the elongate member 42. The screw 64 serves to adjust the transverse position of the elongate member 42 in the elongate hollow portion 60. Two different adjustments of the transverse position of the elongate member 42 in the elongate hollow portion 60 is shown in FIGS. 5a and 5c. The elongate member 42 telescopes with respect to the elongate hollow portion 60 of the pedal body 22 by the action of the screw 64. The second end 48 of the elongate member 42 can be adjusted between the first and second lateral sides 24 and 26 respectively of the pedal body 22.

The distance between the pedal crank and the first lateral side 24 can be changed by adjusting the transverse position of the elongate member 42 in the elongate hollow portion 60. This has the advantage of allowing cyclists with varying degrees of leg rotation in the hip socket to find an appropriate clearance of the pedal body 22 from the pedal crank. By appropriately attaching the cleat to the shoe, the cyclist can mount the shoe on the pedal body 22 with an appropriate amount of toe-in or toe-out rotation without having to be concerned that their heel or toes will interfere with spokes of a wheel or other mechanical components of a bicycle.

The pedal body 22 accommodates a pair of set-screws 68 in respective bores that serve to fix the transverse position of the elongate member 42 in the elongate hollow portion 60 after it has been adjusted by screw 64.

Normally, the longitudinal axis 61 of the elongate hollow portion 60 is parallel to the longitudinal axis 52 of the elongate member 42. However, the elongate hollow portion 60 can be tapered in shape wherein the opening 70 is greater in area than the end 72. The second end 48 of the elongate member 42 is snugly fitted in the elongate hollow portion 60 near the end 72. Referring again to FIGS. 4a-b, a gap 74 is illustrated between the opening 70 and the elongate member 42. Referring to FIGS. 5a-b the elongate member 42 is illustrated in the tapered elongate hollow portion 60.

The tapered elongate hollow portion 60 allows for an adjustment of the longitudinal axis 61 of the elongate hollow portion with respect to the longitudinal axis 52 of the elongate member 42, and therefore also the longitudinal axis 41 of the pedal axle 40. By adjusting the pair of set screws 68 the longitudinal axis 61 of the pedal body 22 can be rotated by ± 5° from the longitudinal axis 41 of the pedal axle 40 in the horizontal plane for a toe-out and toe-in adjustment respectively, and by ± 5° from the longitudinal axis of the pedal axle in the vertical plane for an eversion and inversion adjustment respectively. This has the advantage of allowing a cyclist to find a pedal body 22 position that is appropriate for the natural position of their feet.

Referring back to FIGS. 2a-b the shoe placement means 30 includes a first positioning spring 76, a second positioning spring 78, a screw 80 and a slotted channel 82. The first and second positioning springs, 76 and 78 respectively, are in the form of a helical compression spring. The rear movable hook 34 is positioned in the slotted channel 82 between the first and second positioning springs 76 and 78 respectively. The screw 80 secures the first and second springs, 76 and 78 respectively, and the rear movable hook 34 in the slotted channel 82.

The screw 80 serves to compress the first and second positioning springs 76 and 78 respectively. The springs 76 and 78 operate together to urge the rear movable member 34 into a rest position. When the cyclist engages the shoe placement means 30, they press downwardly with the cleat on the rear movable hook 34 which moves the rear movable hook away from the spring 76. This causes the second positioning spring 78 to compress further allowing the rear moveable hook 34 to move towards the end 36 and the cleat to drop down and contact the shoe side 28. After the cleat drops down the second positioning spring 78 then urges the rear movable hook 34 towards the first positioning spring 76 whereby it hooks the cleat.

To remove the shoe from the adjustable pedal 20, the cyclist rotates the show towards the first lateral side 24 or the second lateral side 28. The cleat transfers the force of rotation to the rear moveable hook 34, which causes the second positioning spring 78 to compress. The rear moveable hook 34 then moves towards the end 36 and thereby provides enough clearance for the cleat to move out of the grasp of the rear moveable hook 34.

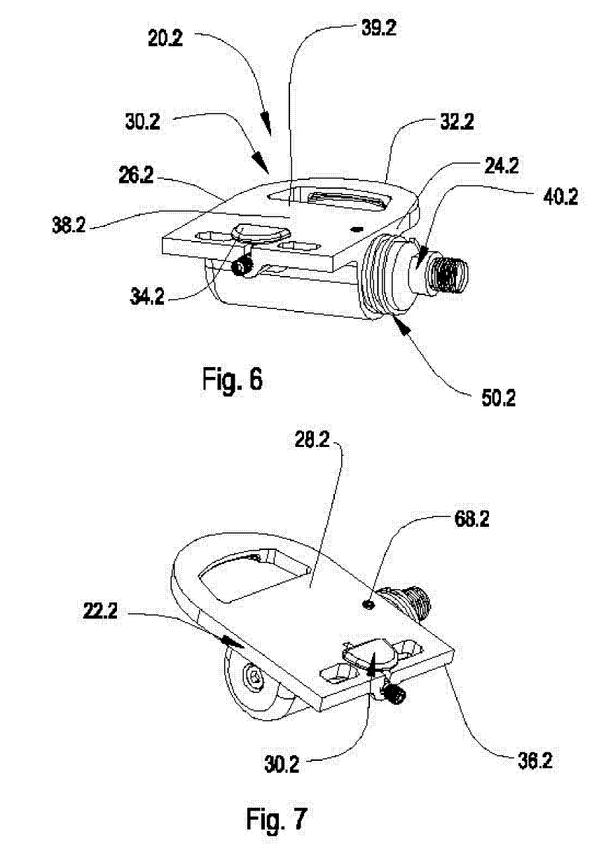

Another embodiment of the present invention is illustrated in FIGS. 6 and 7, wherein like parts to the previous embodiment have like reference numerals with a suffix “.2”. This embodiment is substantially similar to the previous embodiment. In this case, however, an elongate member 40.2 has threads 50.2 on an outer surface. The elongate member 40.2 is threadedly received by an elongate hollow portion.

This embodiment has the advantage of continuous height adjustments between a shoe bearing boundary 39.2 and the pedal axle 30.2. During a rotation of 360° of the pedal axle, the height of the shoe bearing boundary 39.2 above the pedal axle 40.2 is adjusted continuously.

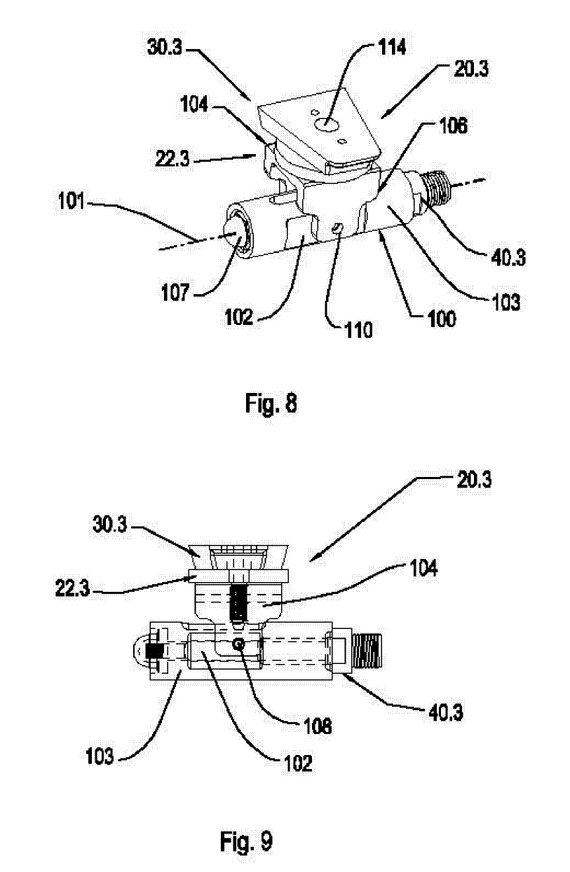

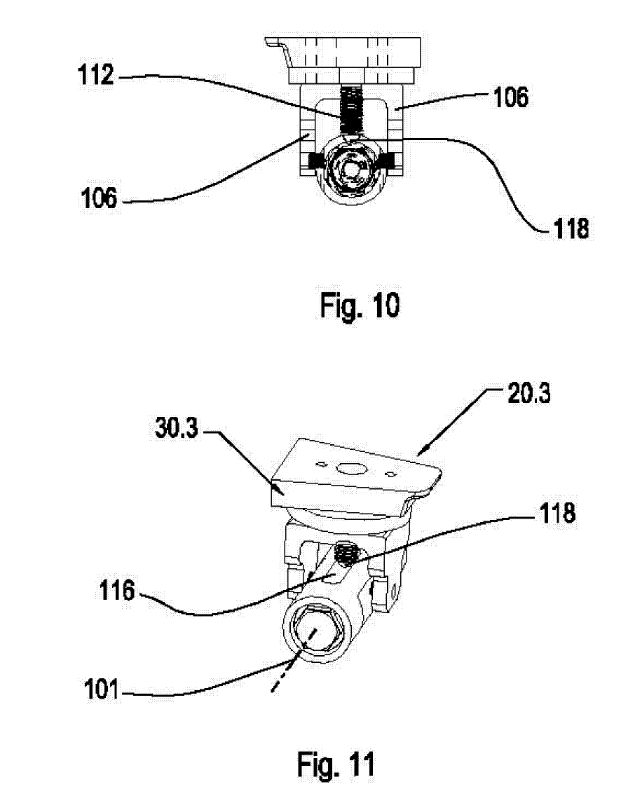

Another embodiment of the present invention is illustrated in FIGS. 8-11, wherein like parts to the previous embodiment have like reference numerals with a suffix “0.3”. An adjustable pedal indicated generally by reference numeral 20.3 includes a pedal body 22.3, a hollow cylindrical member 100 and an axle 40.3. The adjustable pedal shown is for a left foot, however, a similar pedal exists for the right foot.

The hollow cylindrical member 100 receives the axle 40.3 and is secured to the axle by an axle screw 107. The hollow cylindrical member 100 is rotatably coupled to the axle by conventional means, for example, by a pair of ball-bearing assemblies, however, other means are also possible. The ball-bearing assemblies are located at opposite ends of the hollow cylindrical member 100. The axle 40.3 and the hollow cylindrical member 100 have a common longitudinal axis 101.

The hollow cylindrical member 100 includes two opposing planar surfaces 102 on an outer surface 103. The opposing planar surfaces 102 are parallel to each other in this example, but in other embodiments they need not be parallel, and can, for example, be inclined with respect to each other. The hollow cylindrical member 100 further includes a concave shaped trench 116 along the longitudinal axis 101 in the outer surface 103.

The pedal body 22.3 includes a U-shaped, or bifurcated, bracket 104 that slidably straddles the hollow cylindrical member 100. The bracket 104 includes two opposing portions 106 that respectively abut corresponding planar surfaces 102. The opposing portions 106 are parallel to respective planar surfaces 102 in this example, but need not be in other embodiments.

A pair of setscrews 108 fixes the position of the bracket 104 along the longitudinal axis 101 of the hollow cylindrical member 100 by tightening the opposing portions 106 against respective planar surfaces 102. The bracket 104 has opposing bores 110 which threadedly receive respective setscrews 108. The pair of setscrews 108 can be adjusted in the respective bores 110.

The pedal body 22.3 further includes a shoe placement means 30.3, a screw 112 and a bore 114. The bore 114 extends through the shoe placement means 30.3 and the bracket 104. The screw has a tip 118.

The screw 112 is adjusted through bore 114 so that that the screw tip 118 engages the outer surface 103 in the trench 116. The screw 112 adjusts the clearance of the shoe placement means 30.3 from the cylindrical member 100. A longitudinal axis of the screw is typically perpendicular to the longitudinal axis 101. However, the longitudinal axis of the screw can be inclined ± 5 degrees with respect to the longitudinal axis 101 to compensate for eversion or inversion of the foot.

The shoe placement means 30.3 is a cleat engagement mechanism in this example, but can be other types of shoe placement means, such as a pedal platform, or a pedal platform with a cage for the shoe.

As will be apparent to those skilled in the art, modifications can be made to the above-described invention within the scope of the appended claims.

What is claimed is:

1. An adjustable pedal comprising:
a pedal axle having a first end and a second end opposite the first end thereof, the first end being adapted to be fitted to a pedal crank, the pedal axle having a first longitudinal axis and a radial line perpendicular to the longitudinal axis;
a pedal body for supporting a shoe of a cyclist, the pedal body having a first lateral side, a second lateral side and a shoe side, the second lateral side being opposite the first lateral side, the shoe side being between the first lateral side and the second lateral side; and
a pedal adjustment means for adjustably connecting the pedal axle to the pedal body, the first longitudinal axis of the pedal axle being substantially perpendicular to the first and second lateral sides of the pedal body, the pedal adjustment means providing a transverse adjustment for the second end of the pedal axle between the first and second lateral sides, the pedal adjustment means providing a radial adjustment of the pedal body along the radial line of the pedal axle.

2. The adjustable pedal as claimed in claim 1, wherein the pedal adjustment means includes an elongate member and an elongate hollow portion in the first lateral side of the pedal body, the elongate member having a first end and a second end opposite the first end thereof, the first end of the elongate member having a first bore extending towards the second end of the elongate member, the first bore receiving the second end of the pedal axle, the elongate hollow portion extending from the first lateral side of the pedal body towards the second lateral side of the pedal body, the elongate hollow portion receiving the second end of the elongate member, the elongate member being telescopically, mutually engageable with the elongate hollow portion of the pedal body in a plurality of orientations, the shoe side including a shoe placement means for positioning the shoe on the pedal body, the shoe placement means having a plane defining a shoe bearing boundary, the radial line being orthogonal to the plane, the length of a line segment along the radial line extending between the plane and the first longitudinal axis of the pedal axle being different for at least two of the plurality of orientations.

3. The adjustable pedal as claimed in claim 2, wherein the pedal adjustment means further includes a transverse position securing means for fixing the telescopic position of the elongate member in the elongate hollow portion of the pedal body, the transverse position securing means being coupled between the pedal body and the elongate member.

4. The adjustable pedal as claimed in claim 2, wherein the pedal axle is rotatably coupled to the first bore.

5. The adjustable pedal as claimed in claim 2, wherein the elongate member is in the form of a right prism.

6. The adjustable pedal as claimed in claim 1, wherein the pedal adjustment means includes a cylindrical member and a first bore in the first lateral side of the pedal body, the cylindrical member having a first end, a second end opposite the first end thereof, a second longitudinal axis, a second bore in the first end extending towards the second end, an outer surface and threads on the outer surface extending from the second end towards the first end, the pedal axle being rotatably coupled to the second bore, the second longitudinal axis of the cylindrical member being parallel to and offset from the first longitudinal axis of the pedal axle, the first bore extending from the first lateral side towards the second lateral side, the first bore of the pedal body threadedly receiving the second end of the cylindrical member.

7. The adjustable pedal as claimed in claim 6, wherein the pedal adjustment means further includes a transverse position securing means for fixing the transverse position of the cylindrical member in the first bore of the pedal body, the transverse position securing means being coupled between the pedal body and the cylindrical member.

8. The adjustable pedal as claimed in claim 1, wherein the pedal adjustment means includes a hollow cylindrical member and a bifurcated bracket, the hollow cylindrical member having an outer surface, a second longitudinal axis and two opposing planar surfaces on the outer surface, the two opposing planar surfaces extending parallel to the second longitudinal axis, the hollow cylindrical member receiving the pedal axle and being rotatably coupled to the pedal axle, the bifurcated bracket having two opposing portions extending from a middle portion, the two opposing portions straddling the hollow cylindrical member and abutting respective said opposing planar surfaces, and wherein the pedal body includes a shoe placement means for positioning a shoe on the pedal, the shoe placement means being attached to the bifurcated bracket.

9. The adjustable pedal as claimed in claim 8, wherein the pedal adjustment means further includes a slot in each of the opposing portions of the bifurcated bracket and a set screw for each slot for fastening the two opposing portions to respective opposing planar surfaces.

10. The adjustable pedal as claimed in claim 8, wherein the pedal adjustment means further includes a trench in the outer surface of the hollow cylindrical member, a screw and a bore in the middle portion of the bifurcated bracket, the trench extending parallel to the second longitudinal axis of the hollow cylindrical member, the trench being located substantially 90 degrees from each of the opposing planar surfaces along the outer surface, the screw being threadedly received by the bore and an end of the screw engaging the trench, the screw being operable to adjust the clearance of the shoe placement means above the cylindrical member.

11. The adjustable pedal as claimed in claim 8, wherein the pedal further includes an axle screw means for fastening the pedal axle to the hollow cylindrical member, the second end of the pedal axle being received by one end of the hollow cylindrical member, the second end of the pedal axle being adapted to receive the axle screw means at an end of the hollow cylindrical member opposite the one end.

12. The adjustable pedal as claimed in claim 1, wherein the pedal body includes a cleat engagement mechanism.

13. The adjustable pedal as claimed in claim 1, wherein the pedal body includes a pedal platform.

14. In combination, an adjustable pedal and a bicycle, the adjustable pedal comprising:
a pedal axle having a first end and a second end opposite the first end thereof, the first end being adapted to be fitted to a pedal crank, the pedal axle having a first longitudinal axis and a radial line perpendicular to the longitudinal axis;
a pedal body for supporting a shoe of a cyclist, the pedal body having a first lateral side, a second lateral side and a shoe side, the second lateral side being opposite the first lateral side, the shoe side being between the first lateral side and the second lateral side; and
a pedal adjustment means for adjustably connecting the pedal axle to the pedal body, the first longitudinal axis of the pedal axle being substantially perpendicular to the first and second lateral sides of the pedal body, the pedal adjustment means providing a transverse adjustment for the second end of the pedal axle between the first and second lateral sides, the pedal adjustment means providing a radial adjustment of the pedal body along the radial line of the pedal axle.

15. The combination as claimed in claim 14, wherein the pedal adjustment means includes an elongate member and an elongate hollow portion in the first lateral side of the pedal body, the elongate member having a first end and a second end opposite the first end thereof, the first end of the elongate member having a first bore extending towards the second end of the elongate member, the first bore receiving the second end of the pedal axle, the elongate hollow portion extending from the first lateral side of the pedal body towards the second lateral side of the pedal body, the elongate hollow portion receiving the second end of the elongate member, the elongate member being telescopically, mutually engageable with the elongate hollow portion of the pedal body in a plurality of orientations, the shoe side including a shoe placement means for positioning the shoe on the pedal body, the shoe placement means having a plane defining a shoe bearing boundary, the radial line being orthogonal to the plane, the length of a line segment along the radial line extending between the plane and the first longitudinal axis of the pedal axle being different for at least two of the plurality of orientations.

16. The combination as claimed in claim 15, wherein the pedal adjustment means further includes a transverse position securing means for fixing the telescopic position of the elongate member in the elongate hollow portion of the pedal body, the transverse position securing means being coupled between the pedal body and the elongate member.

17. The combination as claimed in claim 16, wherein the pedal axle is rotatably coupled to the first bore.

18. The combination as claimed in claim 14, wherein the pedal adjustment means includes a cylindrical member and a first bore in the first lateral side of the pedal body, the cylindrical member having a first end, a second end opposite the first end thereof, a second longitudinal axis, a second bore in the first end extending towards the second end, an outer surface and threads on the outer surface extending from the second end towards the first end, the pedal axle being rotatably coupled to the second bore, the second longitudinal axis of the cylindrical member being parallel to and offset from the first longitudinal axis of the pedal axle, the first bore extending from the first lateral side towards the second lateral side, the first bore of the pedal body threadedly receiving the second end of the cylindrical member.

19. The combination as claimed in claim 14, wherein the pedal adjustment means includes a hollow cylindrical member and a bifurcated bracket, the hollow cylindrical member having an outer surface, a second longitudinal axis and two opposing planar surfaces on the outer surface, the two opposing planar surfaces extending parallel to the second longitudinal axis, the hollow cylindrical member receiving the pedal axle and being rotatably coupled to the pedal axle, the bifurcated bracket having two opposing portions extending from a middle portion, the two opposing portions straddling the hollow cylindrical member and abutting respective said opposing planar surfaces, and wherein the pedal body includes a shoe placement means for positioning a shoe on the pedal, the shoe placement means being attached to the bifurcated bracket.

20. A method of adjusting a pedal, the pedal comprising a pedal axle having a first end and a second end, the first end being adapted to be fitted to a pedal crank, the pedal axle having a first longitudinal axis and a radial line perpendicular to the longitudinal axis, a pedal body for supporting a shoe of a cyclist, the pedal body having a first lateral side, a second lateral side and a shoe side, the second lateral side being opposite the first lateral side, the shoe side being between the first lateral side and the second lateral side, and a pedal adjustment means for adjustably connecting the pedal axle to the pedal body, the first longitudinal axis of the pedal axle being substantially perpendicular to the first and second lateral sides of the pedal body, the pedal adjustment means providing a transverse adjustment for the second end of the pedal axle between the first and second lateral sides, the pedal adjustment means providing a radial adjustment of the pedal body along the radial line of the pedal axle, the method comprising the steps of:
adjusting the radial distance of the pedal body along the radial line of the pedal axle;
adjusting the transverse position of the second end of the pedal axle between the first and second lateral sides.
